(19) United States
(12) Patent Application Publication
(10) Pub. No.: US 2024/0319493 A1
(43) Pub. Date: Sep. 26, 2024

(54) OPTICAL DEVICES CONFIGURED TO CONTROL A SPACING AND/OR PRESSURE BETWEEN AN OPTICAL ELEMENT AND A SHIFTER AND RELATED METHODS

(71) Applicant: The Government of the United States of America, as represented by the Secretary of the Navy, Arlington, VA (US)

(72) Inventors: Jesse A. Frantz, Washington, DC (US); Jason D. Myers, Alexandria, VA (US); Jasbinder S. Sanghera, Ashburn, VA (US); Robel Y. Bekele, Washington, DC (US); Anthony R. Clabeau, Alexandria, VA (US)

(73) Assignee: The Government of the United States of America, as represented by the Secretary of the Navy, Arlington, VA (US)

(21) Appl. No.: 18/538,614

(22) Filed: Dec. 13, 2023

Related U.S. Application Data
(60) Provisional application No. 63/454,044, filed on Mar. 22, 2023.

(51) Int. Cl. G02B 26/08

(52) U.S. Cl. CPC G02B 26/0875

(57) ABSTRACT

According to some embodiments of the present disclosure, an optical device includes a substrate, an optical element, a shifter, and an actuator. The optical element is on the surface of the substrate, and the shifter is adjacent to the optical element such that the optical element is between the substrate and the shifter. Moreover, the actuator is coupled with the shifter, and the actuator is configured to change a space and/or a pressure between the optical element and the shifter. Related methods are also discussed.

### CROSS-REFERENCE TO RELATED APPLICATIONS

This Application is a Nonprovisional Utility Patent Application and claims the benefit of priority under 35 U.S.C. Sec. 119 based on U.S. Provisional Patent Application No. 63/454,044 filed on Mar. 22, 2023. The disclosure of Provisional Application No. 63/454,044 and all references cited herein are hereby incorporated in their entirety by reference into the present disclosure.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; techtran@nrl.navy.mil, referencing Navy Case #113683-US2.

### TECHNICAL FIELD

The present disclosure relates to optical devices and related methods.

### BACKGROUND OF THE INVENTION

The effective refractive index, n_{eff}, of an optical waveguide is the ratio of the propagation constant of light confined within the waveguide to the free space propagation constant. It is analogous to the refractive index in a bulk material, n, but its value depends both on the values of n of the materials that make up the waveguide and on constraints imposed by the waveguide's geometry. For most waveguides, n_{eff} has a fixed value, but there may be advantages if the effective refractive index can be actively tuned. For example, waveguides with tunable n_{eff} may enable photonic integrated circuit (PIC) components such as switches, modulators, and phased arrays as well as some types of nonmechanical beam steering (NMBS) devices.

Traditional methods of waveguide index control include electro-optic modulators (with devices most commonly fabricated using lithium niobate crystals), liquid crystal-clad waveguides, and micro-electromechanical systems (MEMS). Lithium niobate crystal electro-optic modulators may provide low-loss and high-speed but may suffer from a low change in n_{eff} (Δn_{eff}˜10⁴) and may only operate from the visible through the midwave infrared (MWIR) due to material absorption. Liquid crystal-clad waveguides are currently used in MWIR non-mechanical beam steering (NMBS) chips as discussed, for example, by Frantz, et al., in U.S. Pat. No. 10,690,992, the disclosure of which is hereby incorporated herein in its entirety by reference. These waveguides may be limited, however, in terms of transmission band and/or speed. Micro-electromechanical systems (MEMS) shifting can produce large Δn_{eff} (˜0.03) but may only be realized for a relatively small dimensions (˜100 μm), potentially limiting practical applications.

Chromatic dispersion is the change in phase delay with respect to wavelength, for light propagating within a waveguide, and chromatic dispersion may be fixed for a particular waveguide geometry. However, like control over n_{eff}, control over dispersion may provide advantages. For example, chromatic dispersion may provide tunable phase matching for nonlinear frequency conversion. Nonlinear frequency conversion refers to a set of phenomena in which light at one frequency is shifted to a new frequency as a result of a medium's nonlinear response to an electric field. In order to achieve efficient nonlinear frequency conversion, many nonlinear processes may require phase matching (i.e., controlling the phase fronts of each frequency component involved in the process so that they remain constant relative to each other as the waves propagate). In a bulk medium, phase matching can be achieved using a variety of methods including use of a birefringent crystal and/or by quasi-phase matching (a technique in which the sign of the nonlinearity is varied periodically). In a waveguide, phase matching can be achieved in some cases by designing the waveguide such that its structure uses both the material dispersion of the materials that comprise the waveguide and the waveguide dispersion (i.e., the component of dispersion due to physical constraints of the waveguide) to achieve phase matching. While appealing in theory, phase matching in this manner may be difficult to achieve in practice because slight variations in waveguide fabrication may cause significant differences in waveguide dispersion. Active tuning of the waveguide dispersion, however, may allow improvement/optimization of a given nonlinear conversion process, making it more practical to achieve.

Other processes may benefit from active dispersion control as well. For example, the zero dispersion wavelength (ZDW) of a waveguide occurs at the wavelength for which material dispersion and waveguide dispersion cancel each other. With active phase matching, the ZDW could be shifted. This tuning could have applications such as improving/optimizing soliton transmission and/or improving efficiency of supercontinuum generation. A reconfigurable filter is another nonlinear application. For example, a waveguide with tunable dispersion may be used as a pre-amplifier (placed before a fiber amplifier), and the gain profile of this pre-amplifier could be tailored actively to provide/ensure a desired output from the amplifier (e.g., a flat output spectrum).

### SUMMARY OF THE INVENTION

This summary is intended to introduce in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

According to some embodiments of inventive concepts, an optical device includes a substrate, an optical element, a shifter, and an actuator. The optical element is on a surface of the substrate, and the shifter is adjacent to the optical element such that the optical element is between the substrate and the shifter. The actuator is coupled with the shifter, and the actuator is configured to change a space and/or a pressure between the optical element and the shifter.

The optical device may also include a controller coupled with the actuator. The controller may be configured to apply a first electrical signal to the actuator to provide a first space and/or a first pressure between the optical element and the shifter responsive to the first electrical signal. In addition, the controller may be configured to apply a second electrical signal to the actuator to provide a second space and/or a second pressure between the optical element and the shifter. Moreover, the first space and/or the first pressure may be different than the second space and/or the second pressure.

The actuator may be a piezoelectric actuator having a piezoelectric material between first and second electrodes. Moreover, the controller may be configured to apply the first electrical signal across the first and second electrodes and to apply the second electrical signal across the first and second electrodes. In addition, the piezoelectric material may define a window therethrough.

The optical device may include a laser source configured to provide a laser signal to the optical element. A first effective index and/or a first dispersion may be applied to the laser signal responsive to the first space and/or the first pressure, and a second effective index and/or a second dispersion may be applied to the laser signal responsive to the second space and/or the second pressure, with the first effective index and/or the first dispersion being different that the second effective index and/or the second dispersion.

The optical device may include a laser source configured to provide a laser signal to the optical element. A first tuning of the laser signal may be provided in response to the first spacing and/or the first pressure, and a second tuning of the laser signal may be provided in response to the second spacing and/or the second pressure, with the first and second tunings of the laser signal being different. For example, the laser signal may be a laser beam that is transmitted through the optical element, and the optical element may provide confinement of the laser beam in two dimensions that are orthogonal with respect to a direction of transmission of the laser beam through the optical element.

The optical device may include a laser source configured to provide a laser signal to the optical element. The shifter may be configured to steer the laser signal in a first direction in response to the first spacing and/or the first pressure, and the shifter may be configured to steer the laser signal in a second direction in response to the second spacing and/or the second pressure, with the first and second directions being different. For example, the laser signal may be a laser beam, and the optical element may be a waveguide having a first dimension that is perpendicular with respect to the surface of the substrate and a second dimension that is parallel with respect to the surface of the substrate, with the second dimension being greater than the first dimension. Moreover, the first direction and the second direction may be parallel with respect to the surface of the substrate, the shifter may have at least one side surface that is non-orthogonal with respect to a source direction of the laser signal, and the shifter may have a circular or a triangular shape in a plane that is parallel with the surface of the substrate.

The optical device may include a laser source configured to direct a laser beam to the optical element, and the optical element may be configured to reflect the beam having a first tuning responsive to the first space and/or pressure and to reflect the beam having a second tuning responsive to the second space and/or pressure, with the first and second tunings being different. The optical element may include an array of features having dimensions that are less than a wavelength of the laser signal. For example, the optical element may include a metasurface on the substrate, with the metasurface defining an array of holes and/or pillars having dimensions that are less than a wavelength of the laser signal.

The optical device may include a shifter cladding on the shifter, with the shifter being between the shifter cladding and the optical element, and with a refractive index of the shifter cladding being lower than a refractive index of the shifter. Moreover, the shifter may include a first shifter layer and a second shifter layer having different refractive indices.

According to some other embodiments of inventive concepts, a method of processing a laser signal is provided. The method includes providing the laser signal to an optical element. A first spacing and/or a first pressure is provided between the optical element and a shifter while providing the laser signal to the optical element. After providing the first spacing and/or the first pressure, a second spacing and/or a second pressure is provided between the optical element and the shifter while providing the laser signal to the optical element. Moreover, the first spacing and/or the first pressure is different than the second spacing and/or the second pressure.

The shifter may be coupled with an actuator. Moreover, providing the first spacing and/or the first pressure may include providing a first electrical signal to the actuator, and providing the second spacing and/or the second pressure may include providing a second electrical signal to the actuator, with the first and second electrical signals being different. The actuator, for example, may be a piezoelectric actuator having a piezoelectric material between a first electrode and a second electrode, and each of the first and second electrical signals may be applied across the first and second electrodes.

A first effective index and/or a first dispersion may be applied to the laser signal responsive to the first space and/or the first pressure, and a second effective index and/or a second dispersion may be applied to the laser signal responsive to the second space and/or the second pressure. Moreover, the first effective index and/or the first dispersion may be different that the second effective index and/or the second dispersion.

A first tuning of the laser signal may be provided in response to the first spacing and/or the first pressure, and a second tuning of the laser signal may be provided in response to the second spacing and/or the second pressure, with the first and second tunings of the laser signal being different.

Providing the laser signal may include transmitting a laser beam through the optical element, and the optical element may provide confinement of the laser beam in two dimensions that are orthogonal with respect to a direction of transmission of the laser beam through the optical element.

The laser signal may be steered in a first direction through the optical element in response to the first spacing and/or the first pressure, and the laser signal may be steered in a second direction through the optical element in response to the second spacing and/or the second pressure, with the first and second directions being different. For example, providing the laser signal may include transmitting a laser beam through the optical element, and the optical element may include a waveguide having first and second dimensions that are orthogonal with respect to each other and that are orthogonal with respect to a source direction of transmission of the laser beam, with the second dimension being greater than the first dimension and greater than a width of the laser beam.

The optical element may be configured to reflect the laser signal having a first tuning responsive to the first space and/or pressure and to reflect the laser signal having a second tuning responsive to the second space and/or pressure, with the first and second tunings being different. Moreover, the optical element may include a metasurface on a substrate, and the metasurface may include an array of features having dimensions that are less than a wavelength of the laser signal. For example, the array may include an array of holes and/or pillars.

### BRIEF DESCRIPTION OF DRAWINGS

Examples of embodiments of inventive concepts may be more clearly understood from the following detailed description taken in conjunction with the accompanying drawings in which:

FIG. 1A is a side view of an optical device according to some embodiments of inventive concepts with a shifter spaced apart from a waveguide core, FIG. 1B is a sectional view taken along section line 1B of FIG. 1A, FIG. 1C is a sectional view taken along section line 1C of FIG. 1A, and FIG. 1D is a top view of a system including the optical device of FIG. 1A;

FIG. 2A is a side view of an optical device according to some embodiments of inventive concepts with a shifter on waveguide core, FIG. 2B is a sectional view taken along section line 2B of FIG. 2A, and FIG. 2C is a sectional view taken along section line 2C of FIG. 2A;

FIG. 2D is a side view of the shifter of FIG. 2A applying pressure to the waveguide core according to some embodiments of inventive concepts;

FIG. 3 is a side view of a shifter of either FIG. 1A or FIG. 2A including two layers with different optical properties;

FIG. 4 is a side view of an optical device according to some embodiments of inventive concepts with a shifter spaced apart from a planar waveguide;

FIG. 5 is a side view illustrating a piezoelectric actuator structure according to some embodiments of inventive concepts where the top electrode and the support are integrated;

FIG. 6 is a graph illustrating effective refractive index n_{eff} as a function of shifter spacing determined based on simulation according to some embodiments of inventive concepts with insets illustrating calculated mode profiles for shifter spacings of 0 nm and 300 nm;

FIG. 7A is a side view illustrating a glass waveguide core with dimensions of 400 nm by 400 nm and shifter spacings ranging from 0 to 300 nm according to some embodiments of inventive concepts, and FIGS. 7B and 7C illustrate plots of mode for shifter spacings of 0 nm and 300 nm respectively based on modeling;

FIG. 8A is a side view illustrating a glass waveguide core with dimensions of 500 nm by 500 nm and shifter spacings ranging from 0 to 300 nm according to some embodiments of inventive concepts, and FIGS. 8B and 8C illustrate plots of mode for shifter spacings of 0 nm and 300 nm respectively based on modeling;

FIG. 9A is a side view illustrating an As₂S₃ waveguide core with dimensions of 1000 nm by 1000 nm, a two layer shifter, and shifter spacings ranging from 0 to 300 nm according to some embodiments of inventive concepts, and FIGS. 9B and 9C illustrate plots of mode for shifter spacings of 0 nm and 300 nm respectively based on modeling;

FIG. 10A is a side view illustrating an As₂S₃ waveguide core with dimensions of 5000 nm by 5000 nm and shifter spacings ranging from 0 to 600 nm according to some embodiments of inventive concepts, and FIGS. 10B and 10C illustrate plots of mode for shifter spacings of 0 nm and 600 nm respectively;

FIG. 11A is a side view illustrating an As₂S₃ waveguide core with dimensions of 6000 nm by 6000 nm and shifter spacings ranging from 0 to 1500 nm according to some embodiments of inventive concepts, and FIGS. 11B and 11C illustrate plots of mode for shifter spacings of 0 nm and 1500 nm respectively;

FIG. 12A is a side view of an optical device according to some embodiments of inventive concepts with a shifter spaced apart from a metasurface MS, FIG. 12B is a sectional view taken along section line 12B of FIG. 12A, FIG. 12C is a sectional view taken along section line 12C of FIG. 12A, and FIG. 12D is an expanded view of the metasurface of FIG. 12A;

FIG. 13 is a graph illustrating tuning of reflected wavelength resonance in response to varying shifter spacings according to some embodiments of inventive concepts;

FIG. 14A is a side view of an optical device on a precision rotation stage according to some embodiments of inventive concepts, FIG. 14B is an expanded view of the waveguide and shifter/cladding of FIG. 14A, FIG. 14 C is a graph illustrating steering angle as a function of voltage for the optical device of FIG. 4A, and FIGS. 14D and 14E illustrate outputs at 0 volt and 15 volt inputs for the piezoelectric actuator

FIG. 15A is a side view of an optical device according to some embodiments of inventive concepts, FIG. 15B is a sectional view taken along section line 15B of FIG. 15A, and 15C is a sectional view taken along section line 15C of FIG. 15A;

FIG. 16A is a side view of an optical device according to some embodiments of inventive concepts, FIG. 16B is a sectional view taken along section line 16B of FIG. 16A, and FIG. 16C is a sectional view taken along section line 16C of FIG. 16A;

FIG. 17A is a side view of an optical device according to some embodiments of inventive concepts, FIG. 17B is a sectional view taken along section line 17B of FIG. 17A, and FIG. 17C is a sectional view taken along section line 17C of FIG. 17A; and

FIG. 18A is a side view of an optical device according to some embodiments of inventive concepts, FIG. 18B is a sectional view taken along section line 18B of FIG. 18A.

### DETAILED DESCRIPTION OF THE INVENTION

Aspects and features of the present disclosure will now be described more fully with reference to the accompanying drawings. The following description shows, by way of example, combinations and configurations in which aspects, features, and embodiments of inventive concepts can be put into practice. It will be understood that the disclosed aspects, features, and/or embodiments are merely examples, and that one skilled in the art may use other aspects, features, and/or embodiments or make functional and/or structural modifications without departing from the scope of the present disclosure. Moreover, like reference numerals refer to like elements throughout, and sizes of each of the elements may be exaggerated for clarity and conveniences of explanation.

According to some embodiments of inventive concepts, devices and methods may provide active control of an effective refractive index n_{eff} and/or dispersion dn/dλ for integrated optic waveguides over large areas. In a linear regime in which an optical structure exhibits a linear response to an electromagnetic field, some embodiments may provide improved (e.g., high/increased throughput, high/increased speed, low/reduced size-weight-and-power low-SWaP, etc.) non-mechanical beam steering (NMBS) in multiple bands of interest, and/or photonic integrated circuit (PIC) components. In a nonlinear regime, some embodiments may provide active dispersion control for dynamically tunable nonlinear processes (e.g., tunable phase matching for nonlinear frequency conversion) and/or reconfigurable filters. Moreover, a large area may be provided for both NMBS and actively tuned nonlinear frequency conversion. Applications for some embodiments may thus include non-mechanical beam steering, photonic integrated circuits (e.g., switches, modulators, phased arrays, etc.), tunable phase matching for nonlinear frequency conversion, reconfigurable filters, tunable metamaterials with broadly tunable optical responses, etc.

According to some embodiments of inventive concepts, a piezoelectric actuator may be used to operate a shifter (i.e., an optically transparent section of a waveguide that changes the waveguide's n_{eff} and/or dispersion), through mechanical motion and/or changes in pressure. Use of a piezoelectrically actuated shifter may provide one or more of the following advantages: low optical loss (near intrinsic waveguide loss); high speed (potentially >100 kHz); capacity to modify index n_{eff} over a large area (several cm² and larger); and/or wavelength independence (i.e., the method may work in any band as long as appropriate waveguide materials exist). Modelling of one embodiment shows that values of Δn_{eff} of >0.05 may be realizable with a shift of only about 300 nm in magnitude and that realistic designs may exist in wavelength bands from the ultraviolet through the Long Wavelength Infrared (LWIR). These methods may be extended beyond this wavelength range as well to any band for which a waveguide could be fabricated.

According to some embodiments of inventive concepts, performance of existing integrated optic devices may be improved and/or new integrated optic devices may be enabled. For NMBS, for example, a reduction of about 10× in loss may be provided, an increase of about 5× in field of regard and/or in steering may be provided, and/or an increase in speed of about 100× may be provided. In the nonlinear regime, few if any practical methods of active dispersion control may exist, so that some embodiments of inventive concepts may enable entirely new types of devices. According to some additional embodiments, piezoelectrically actuated shifters may be applied to tunable metamaterials where the technology may be leveraged to build metasurfaces with broadly tunable optical responses.

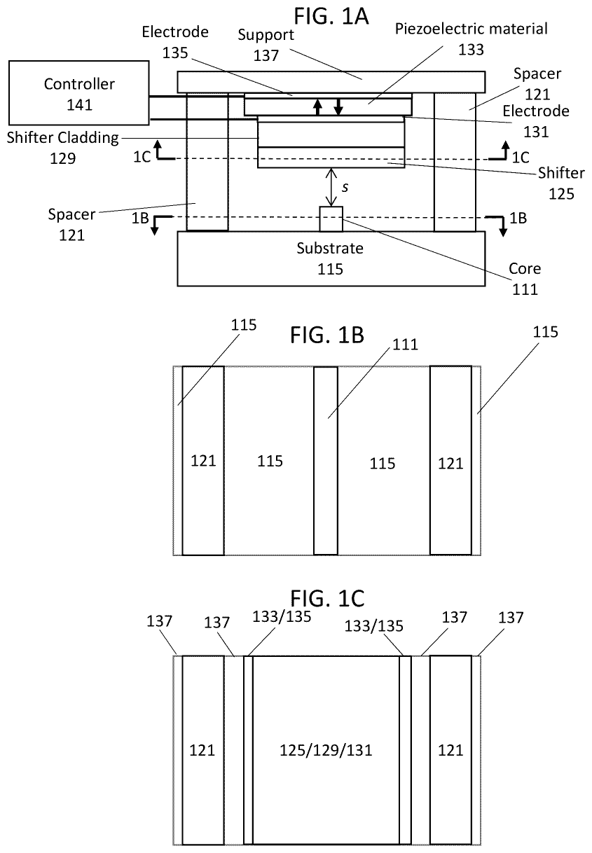

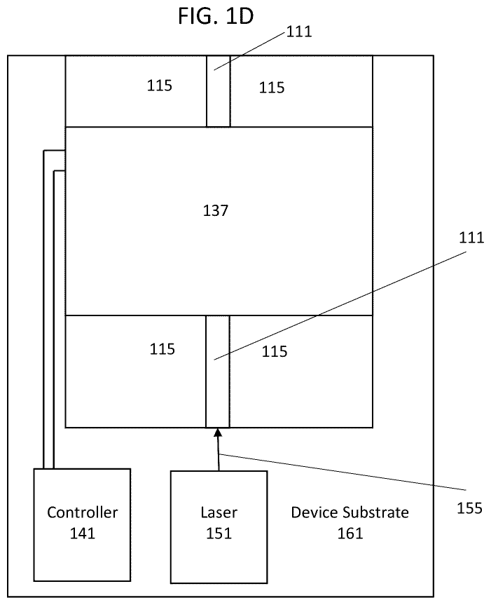

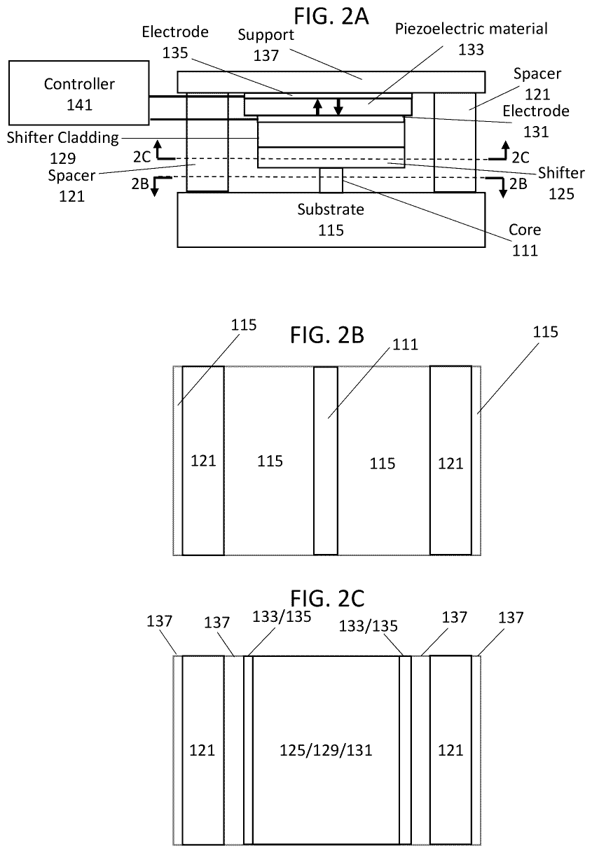

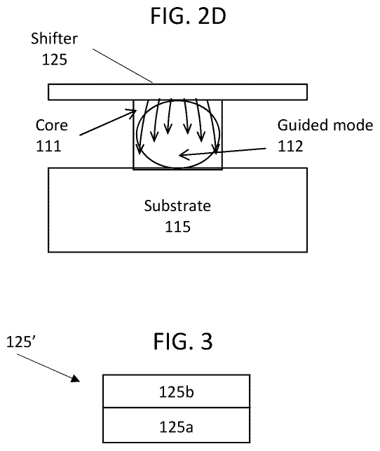

Some embodiments of inventive concepts include an integrated optic waveguide and a shifter. The shifter is a structure that is transparent in a wavelength range of interest, where the shifter is controlled by a piezoelectric actuator (also referred to as a transducer). The shifter may be physically separated from the waveguide by a variable spacing that is controlled by the actuator, as discussed below with respect to FIGS. 1A, 1B, and 1C. Alternately, the shifter may be in contact with the waveguide, and the shifter may apply a pressure to the waveguide with a magnitude controlled by the actuator, as discussed below with respect to FIGS. 2A, 2B, and 2C.

Some embodiments of inventive concepts are shown in the cross sectional views of FIGS. 1A, 1B, and 1C. The waveguide includes core 111 on substrate 115. The shifter 125 is shown spaced apart from (e.g., displaced above) core 111 by a shifter spacing s which is variable depending on a control signal applied by controller 141 through electrodes 131 and 135. Shifter cladding 129 may be located between shifter 125 and electrode 131. Shifter cladding 129 has a lower refractive index than shifter 125 to reduce a fraction of light that is present in shifter cladding 129. The waveguide (including substrate 115 and core 111), shifter 125, and shifter cladding 129 are all transparent with respect to the wavelength range of interest. A piezoelectric actuator includes piezoelectric material 133 (e.g., lead zirconate titanate, Pb(ZrₓTi₁₋ₓ)O₃ (PZT)), first and second electrodes 131 and 135, and piezoelectric controller 141 (shown schematically) coupled to electrodes 131 and 135. Shifter 125, shifter cladding 129, piezoelectric material 133, and electrodes 131 and 135 together make up a shifter assembly. The shifter assembly is attached to a rigid piezoelectric support 137. In some embodiments, piezoelectric support 137 (or some portion thereof) may be conductive and thereby also serve as electrode 135. Alternately, piezoelectric support 137 and electrode 135 can be separate layers as shown in FIG. 1A. The shifter assembly is supported by spacers 121. The piezoelectric actuator controls spacing s, which is the position/distance that shifter 125 is spaced apart from core 111 of the waveguide.

FIG. 1D illustrates a top schematic view of the optical device including the elements discussed above with respect to FIGS. 1A, 1B, and 1C with controller 141 and laser 151 on a device substrate 161, such as a printed circuit board and/or semiconductor substrate. With device substrate 161 implemented as a printed circuit board, for example, the optical device (including substrate 115, spacers 121, shifter 125, shifter cladding 129, piezoelectric material 133, electrodes 131 and 135, and support 137), controller 141, and/or laser 151 may be fabricated separately and mounted on the printed circuit board. With device substrate 161 implemented as a semiconductor substrate, one or more of the optical device, controller 141, laser 161, and/or elements thereof may be fabricated directly on the semiconductor substrate, and/or substrate 115 may provide the semiconductor substrate. While controller 141 and laser 151 are shown on device substrate 161 in the embodiment of FIG. 1D, one or both of controller 141 and/or laser 151 may be provided apart from device substrate 161 and electrically/optically coupled therewith.

During operation, a light source (e.g., laser 151) generates a light signal (e.g., laser signal 155) that is coupled into core 111, and piezoelectric controller 141 (also referred to as a controller) is used to apply an electrical signal (e.g., a voltage signal) across electrodes 131 and 135 on opposite sides of piezoelectric material 133. When the signal/voltage from controller 141 changes, spacing s changes. Because the shifter assembly (including shifter 125) is proximate to the waveguide (including core 111), its presence changes the profile of a mode propagating within core 111 of the waveguide. The motion of shifter 125 (resulting in a change in spacing s) may thus change an optical property experienced by laser signal 155 passing through the optical device (e.g., changing n_{eff} and/or dispersion of core/shifter 111/125) through a combination of two mechanisms. First, the presence of shifter 125 changes a distribution of the mode among the component materials (e.g., as the shifter assembly moves shifter 125 closer to core 111 of the waveguide, more light of laser signal 155 is concentrated within shifter 125 and shifter cladding 129 and less light of laser signal 155 is concentrated in core 111), so that a weighted average of the refractive index and dispersion of the materials sampled by the light is varied. Second, the changing spatial configuration results in changes in mode profile, resulting in changes in n_{eff} and dispersion that are independent of material considerations. Stated in other words, as the gap s varies, the waveguide remains single mode but the structural change results in a change in n_{eff}. The value of s, and thus the values of n_{eff} and the dispersion profile, may be varied as desired. The distance s can be actively controlled using piezoelectric controller 141, with or without a feedback loop, or varied according to a prescribed pattern. Accordingly, laser signal 155 passing through core 111 (e.g., a frequency of laser signal 155) may be actively tuned by changing the spacing s.

FIGS. 2A, 2B, 2C, and 2D illustrate another embodiment where, rather than being separated by a distance s, shifter 125 is in contact with core 111 of the waveguide, and a variable pressure is applied between shifter 125 and core 111. FIG. 2D is an expanded cross sectional view illustrating portions of substrate 115, core 111, and shifter 125 of FIGS. 2A, 2B, and 2C. In FIG. 2D, the arrows through core 111 indicate the pressure distribution within the waveguide core 111. Note that for FIG. 2D, only the substrate 115, core 111, and shifter 125 are shown for simplicity. In this case, n_{eff} is varied through the stress-optic coefficient of the material (i.e., applying/changing pressure via the piezoelectric actuator changes a refractive index within the waveguide material/materials and thus also changes n_{eff}). Dispersion may be varied due to the pressure-dependence of the material dispersion profile, due to changes in distribution of the mode among component materials, and/or due to changes in mode profile. Tuning is thus achieved through index modification of the waveguide material via the stress-optic coefficient. Operations and structures of embodiments of FIGS. 2A, 2B, 2C, and 2D may be substantially the same as those discussed above with respect to operations and structures of FIGS. 1A, 1B, 1C, and 1D except that shifter 125 and core 111 are in contact, and changes in pressure (instead of changes in spacing) are used to change optical properties experienced by the laser signal.

FIG. 3 shows another embodiment where the shifter 125′ includes two layers 125a and 125b with different optical properties (with layer 125a between layer 125b and core 111), providing better control over n_{eff} and/or dispersion. For example, the layer 125a (adjacent to core 111) may have a relatively higher refractive index and the layer 125b (adjacent to the piezoelectric actuator) may have a relatively lower refractive index, where the refractive indices and thicknesses of both layers 125a and 125b are provided/optimized to increase/maximize n_{eff} while maintaining single mode operation of the waveguide. Shifter 125′ of FIG. 3 may be substituted for shifter 125 of either FIGS. 1A-C or FIGS. 2A-D.

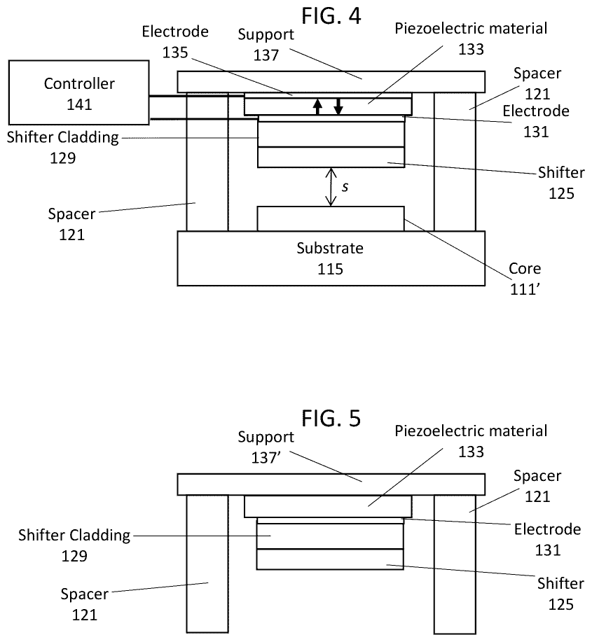

FIG. 4 shows another embodiment where core 111′ extends laterally in a direction parallel with respect to a surface of substrate 115 and perpendicular with respect to a direction of light through the waveguide so that the waveguide provides a substantially planar waveguide with limited/no confinement in the lateral dimension. In this case, the laser signal may be a collimated input laser beam, with collimation of beam rather than waveguide confinement dictating the lateral distribution of light. The embodiment of FIG. 4 may be directly applicable to the case of an NMBS device where the waveguide may be a planar waveguide structure. Operations and structures of embodiments of FIG. 4 may be substantially the same as those discussed above with respect to operations and structures of embodiments of FIGS. 1A, 1B, 1C, and 1D except that core 111′ provides a substantially planar waveguide. According to some other embodiments of FIG. 4, shifter 125 may be directly on core 111′ (i.e., s=0) with changes in pressure used to change the effective refractive index as discussed above with respect to FIGS. 2A, 2B, 2C, and 2D.

FIG. 5 is a cross sectional view illustrating an alternative where a conductive support 137′ also acts as the upper electrode so that a separate upper electrode is not required. For example, conductive support 137′ may be substituted for support 137 and electrode 135 of FIGS. 1A, 2A, and 4.

A variety of options can be used for the piezoelectric material 133 of either of FIG. 1A, 2A, or 4. Possibilities include, but are not limited to, single crystal or polycrystalline thin film materials including PZT, potassium sodium niobate (K,Na)NbO₃ (KNN), or quartz. Organic material such as polyvinylidene chloride/fluoride (PVDC/PVDF), which can be deposited via spin coating, could also be used. The thin film piezoelectric material can optionally be patterned in any desired pattern via photolithography.

If a thin film piezoelectric material is used, the fabrication process can be outlined as follows: 1) Deposit electrode 135 onto support 137; 2) Deposit piezoelectric material 133 on electrode 135; 3) Optionally, pattern piezoelectric material 133 via photolithography; and 4) Form/assemble spacers 121 on support 137. Spacers 121 may be formed/assembled by using vacuum deposition and lithography, by bonding spacers 121 to support 137, by depositing pre-formed spacers 121 suspended in solution, or by some other suitable technique. Additional fabrication operations may include: 5) Optionally, planarize spacers 121 and piezoelectric material 133 together; 6) Deposit bottom electrode 131 on piezoelectric material 133; and 7) Form shifter cladding 129 (if shifter cladding is used) and shifter 125 on bottom electrode 131. The shifter cladding 129 (if used) and shifter 125 may be fabricated on the piezoelectric material using conventional vacuum deposition techniques, solution-based deposition methods, or pick-and-place assembly depending on the desired material and dimensions. Additional fabrication operations may include: 7) Attach structure including support 137, spacers 121, piezoelectric material 133, electrodes 131 and 135, shifter cladding 129 (if used), and shifter 125 to substrate 115 by bonding spacers 121 to substrate 115.

Alternately, piezoelectric material 133 could be a bulk crystal or a ceramic piece of PZT, KNN, or other bulk material attached to piezoelectric support 137. In this case, piezoelectric material 133 may not be sufficiently smooth to provide accurate control of n_{eff} and dispersion over large areas and/or might not be the same height as spacers 121 (as shown in FIG. 5). In this case, a planarization operation such as chemical-mechanical polishing (CMP) could be used to achieve uniform thickness and a smooth finish. An outline of these fabrication operations may include: 1) Fabricate waveguide (including core 111) on substrate 115; 2) Bond piezoelectric material 133 to support 137 (including electrode 135); 3) Bond spacers 121 to support 137; 4) Planarize spacers 121 and piezoelectric material 133 together; 5) Deposit bottom electrode 131 on piezoelectric material 133; 6) Form shifter cladding 129 (if used) and shifter 125 on bottom electrode 131. Shifter cladding 129 and shifter 125 may be fabricated on piezoelectric material 133 using conventional vacuum deposition techniques, solution-based deposition methods, or pick-and-place assembly depending on the desired material and dimensions. Additional fabrication operations may include: 7) Attach structure including support 137, spacers 121, piezoelectric material 133, electrodes 131 and 135, shifter cladding 129 (if used), and shifter 125 to substrate 115 by bonding spacers 121 to substrate 115.

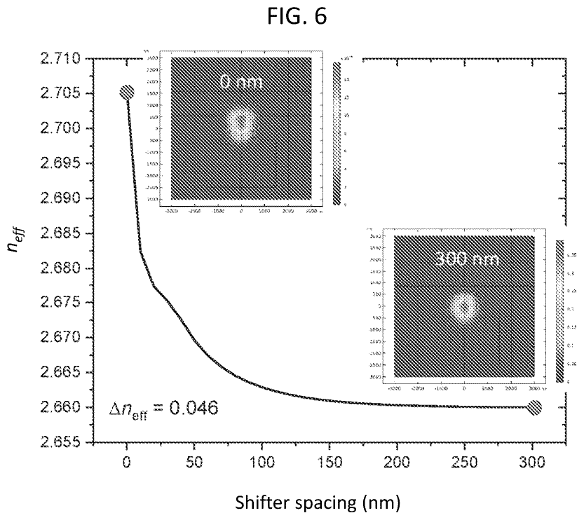

Some embodiments of inventive concepts have been modeled using finite element method (FEM) modelling. An example is shown in FIG. 6 with a plot showing n_{eff} as a function of spacing s for the structure discussed above with respect to FIGS. 1A, 1B, and 1C. For the example modeled in FIG. 6, the wavelength is 1550 nm, the material of substrate 115 is arsenic sulfide (As₂S₃), waveguide core 111 is arsenic selenide (As₂Se₃) with a square cross section with cross sectional dimensions of 1 μm×1 μm, and shifter 125 is two layers (as discussed with respect to FIG. 3) with a 1 μm thick top layer 125b of As₂S₃ and a 70 nm thick bottom layer 125a of silicon (such that the silicon layer is between the As₂S₃ layer and core 111). In the simulation of FIG. 6, spacing s is varied from 0-300 nm as shown on the x-axis. The resulting Δn_{eff} is 0.046, changing from 2.706 to 2.660 on the y-axis. The calculated mode profiles for values of spacing s of 0 and 300 nm are shown as insets on the plot. While the mode is nearly symmetric for s=300 nm, the asymmetry of the mode can be seen for s=0 nm, indicating that the impact of shifter 125 on the mode profile is clearly evident.

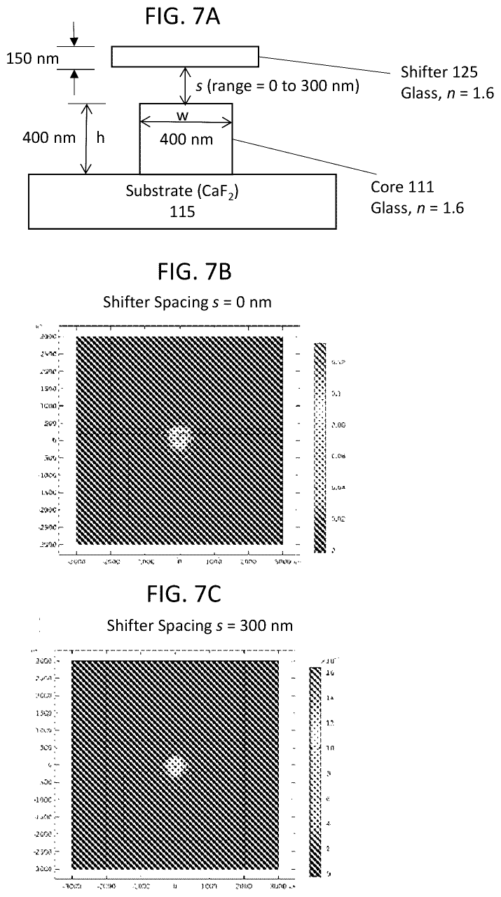

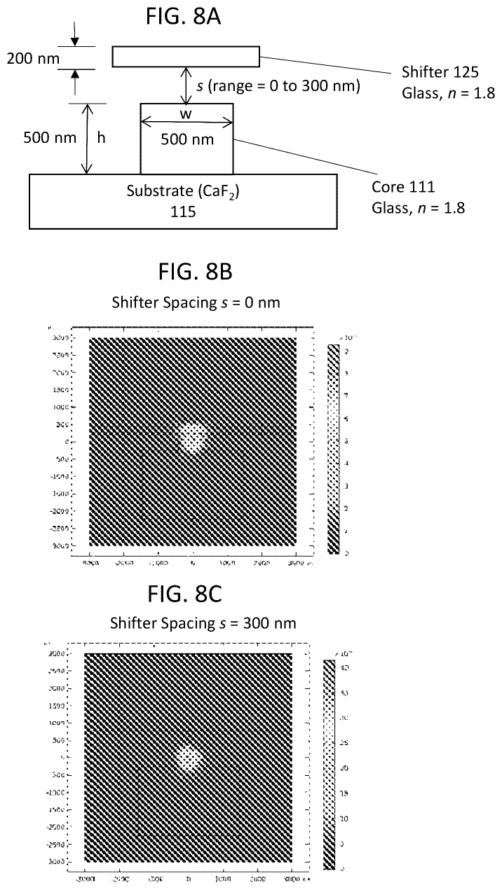

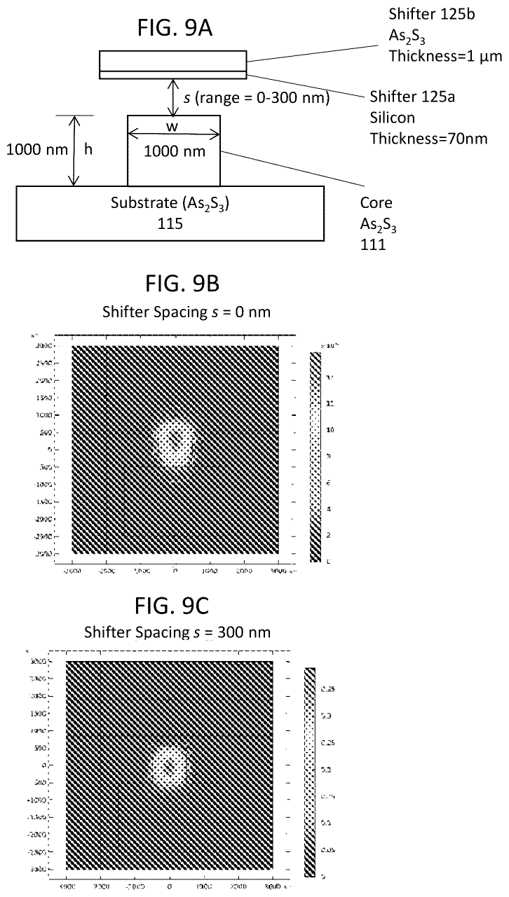

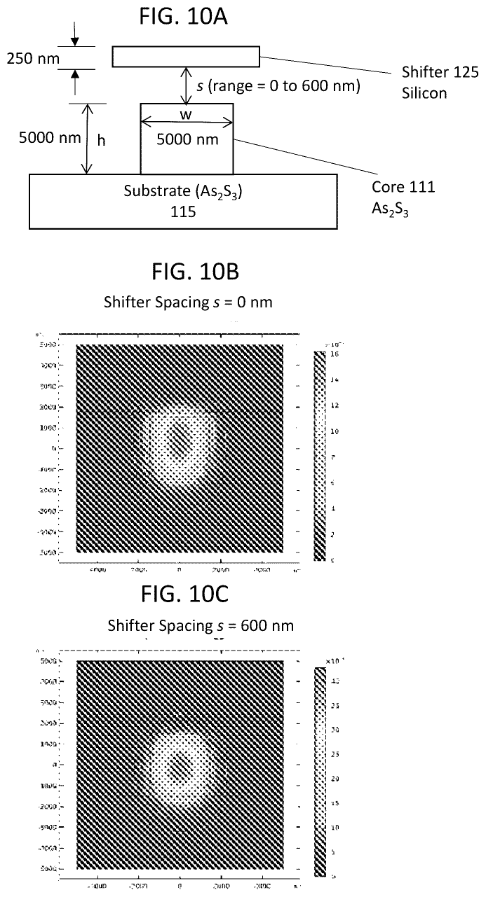

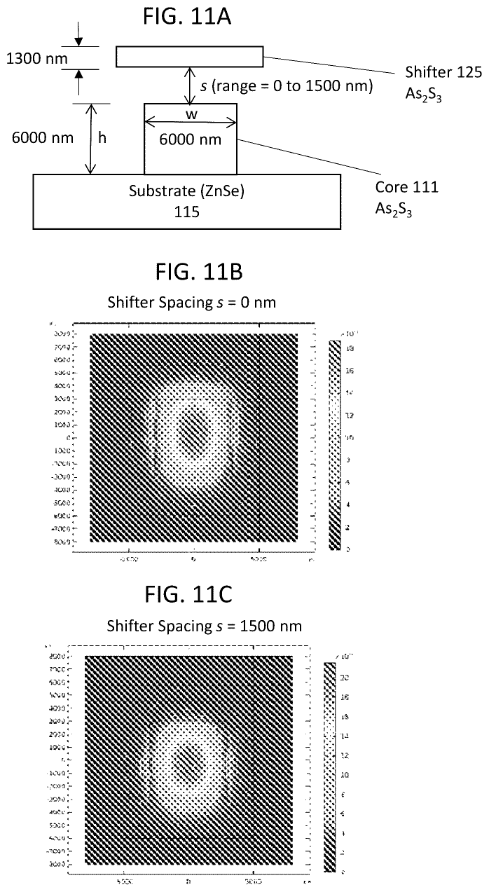

Example designs for various bands are shown in FIGS. 7A-C (for ultraviolet radiation at 380 nm providing Δn_{eff}=0.02), in FIGS. 8A-C (for visible radiation at 633 nm providing Δn_{eff}=0.04), in FIGS. 9A-C (for short-wave infrared SWIR radiation at 1550 nm providing Δn_{eff}=0.046), in FIGS. 10A-C (for mid-wave infrared MWIR radiation at 4600 nm providing Δn_{eff}=0.027), and in FIGS. 11A-C (for longwave infrared LWIR radiation at 10600 nm providing Δn_{eff}=0.026). Each of these designs was modeled using FEM modelling, and a working configuration was found for each band. All models used a square rib waveguide such that the cross sectional height h is equal to the cross sectional width w. In each of FIGS. 7A, 8A, 9A, 10A, and 11A, the structure of FIGS. 1A, 1B, 1C, and 1D was used, but some elements of FIG. 1A are omitted from FIGS. 7A, 8A, 9A, 10A, and 11A for the sake of conciseness and to better illustrate dimensions/materials of particular elements. Accordingly, it will be understood that embodiments of each of FIGS. 7A, 8A, 9A, 10A, and 11A may include one or more of spacers 121, shifter cladding 129, electrodes 131 and 135, piezoelectric material 133, support 137, and/or controller 141.

The embodiment of FIG. 7A was modeled based on a design wavelength of 380 nm, and with a range of spacing s (between core 111 and shifter 125) from 0 nm to 300 nm (determined by controller 141 and piezoelectric material 133). In the embodiment of FIG. 7A, substrate 115 is CaF₂; core 111 is glass with n=1.6 and cross sectional dimensions of 400 nm×400 nm; and shifter 125 is glass with n=1.6 and a thickness of 150 nm. By varying spacing s from 0 to 300 nm, a change in n_{eff} of 0.02 was achieved (i.e., Δn_{eff}=0.02). FIG. 7B is a plot of the mode for the solution for s=0 in FIG. 7A, and FIG. 7C is a plot of the mode for the solution for s=300 nm in FIG. 7A.

The embodiment of FIG. 8A was modeled based on a design wavelength of 633 nm, and with a range of spacing s (between core 111 and shifter 125) from 0 nm to 300 nm (determined by controller 141 and piezoelectric material 133). In the embodiment of FIG. 8A, substrate 115 is CaF₂; core 111 is glass with n=1.8 and cross sectional dimensions of 500 nm×500 nm; and shifter 125 is glass with n=1.8 and a thickness of 200 nm. By varying spacing s from 0 to 300 nm, a change in n_{eff} of 0.04 was achieved (i.e., Δn_{eff}=0.04). FIG. 8B is a plot of the mode for the solution for s=0 in FIG. 8A, and FIG. 8C is a plot of the mode for the solution for s=300 nm in FIG. 8A.

The embodiment of FIG. 9A was modeled based on a design wavelength of 1550 nm, and with a range of spacing s (between core 111 and shifter 125) from 0 nm to 300 nm (determined by controller 141 and piezoelectric material 133). In the embodiment of FIG. 9A, substrate 115 is As₂S₃; and core 111 is As₂S₃ with cross sectional dimensions of 1000 nm×1000 nm. Moreover, shifter 125 may have a two layer structure as discussed above with respect to FIG. 3, with shifter layer 125a being a 70 nm thick layer of silicon and shifter layer 125b being a 1 μm thick layer of As₂S₃. By varying spacing s from 0 to 300 nm, a change in n_{eff} of 0.046 was achieved (i.e., Δn_{eff}=0.046). FIG. 9B is a plot of the mode for the solution for s=0 in FIG. 9A, and FIG. 9C is a plot of the mode for the solution for s=300 nm in FIG. 9A.

The embodiment of FIG. 10A was modeled based on a design wavelength of 4600 nm, and with a range of spacing s (between core 111 and shifter 125) from 0 nm to 600 nm (determined by controller 141 and piezoelectric material 133). In the embodiment of FIG. 10A, substrate 115 is As₂S₃; core 111 is As₂S₃ with cross sectional dimensions of 5000 nm×5000 nm; and shifter 125 is silicon with a thickness of 250 nm. By varying spacing s from 0 to 600 nm, a change in n_{eff} of 0.027 was achieved (i.e., Δn_{eff}=0.04). FIG. 10B is a plot of the mode for the solution for s=0 in FIG. 10A, and FIG. 10C is a plot of the mode for the solution for s=600 nm in FIG. 10A.

The embodiment of FIG. 11A was modeled based on a design wavelength of 10600 nm, and with a range of spacing s (between core 111 and shifter 125) from 0 nm to 1500 nm (determined by controller 141 and piezoelectric material 133). In the embodiment of FIG. 11A, substrate 115 is ZnSe; core 111 is As₂S₃ with cross sectional dimensions of 6000 nm×6000 nm; and shifter 125 is A₂S₃ with a thickness of 1300 nm. By varying spacing s from 0 to 1500 nm, a change in n_{eff} of 0.026 was achieved (i.e., Δn_{eff}=0.026). FIG. 11B is a plot of the mode for the solution for s=0 in FIG. 11A, and FIG. 11C is a plot of the mode for the solution for s=1500 nm in FIG. 11A.

Parameters for each band and the resulting values for Δn_{eff} for each of FIGS. 7A-C, 8A-C, 9A-C, 10A-C, and 11A-C are summarized below in Table 1.

TABLE 1
Parameters for model and results for each band

| | Design | | | Core | | Shifter | s | |
|---|---|---|---|---|---|---|---|---|
| | wavelength | Substrate | Core | dimension | Shifter | thickness | range | |
| Band | (nm) | material | material | (nm) | material | (nm) | (nm) | Δn_{eff} |
| Ultraviolet | 380 | CaF₂ | Glass, | 400 | Glass, | 150 | 0-300 | 0.02 |
| FIGS. 7A-C | | | n = 1.6 | | n = 1.6 | | | |
| Visible | 633 | CaF₂ | Glass, | 500 | Glass, | 200 | 0-300 | 0.04 |
| FIGS. 8A-C | | | n = 1.8 | | n = 1.8 | | | |
| SWIR | 1550 | As₂S₃ | As₂Se₃ | 1000 | Top: | Top: | 0-300 | 0.046 |
| FIGS. 9A-C | | | | | As₂S₃ | 1000 | | |
| | | | | | Bottom: | Bottom: | | |
| | | | | | Si | 70 | | |
| MWIR | 4600 | As₂S₃ | As₂Se₃ | 5000 | Si | 250 | 0-600 | 0.027 |
| FIGS. 10A-C | | | | | | | | |
| LWIR | 10600 | ZnSe | As₂Se₃ | 6000 | As₂Se₃ | 1300 | 0-1500 | 0.026 |
| FIGS. 11A-C | | | | | | | | |

Table 1 thus shows results of modeling in different bands from ultraviolet (k=380 nm) through longwave infrared (k=10.6 μm) with different materials and dimensions, and each model/band demonstrated Δn_{eff} of at least 0.02.

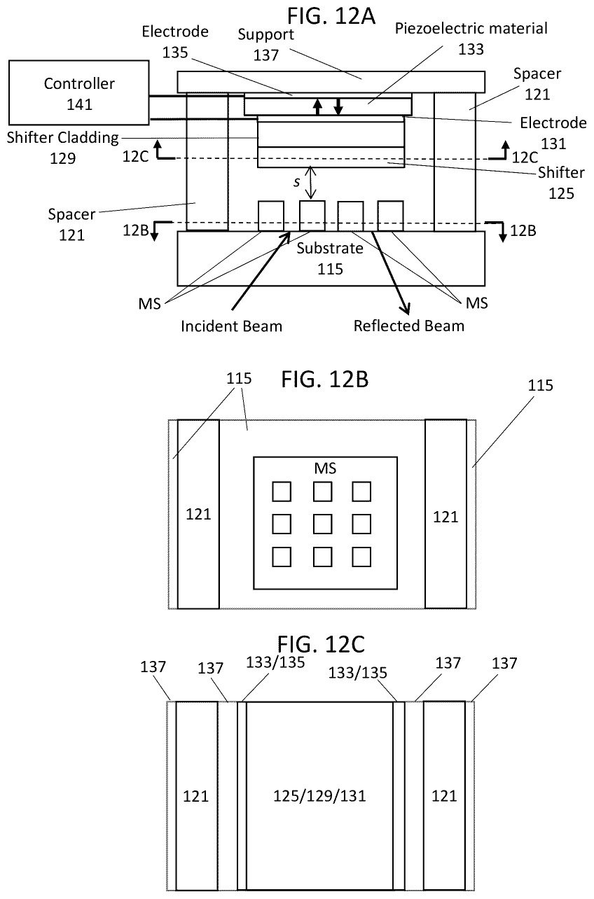

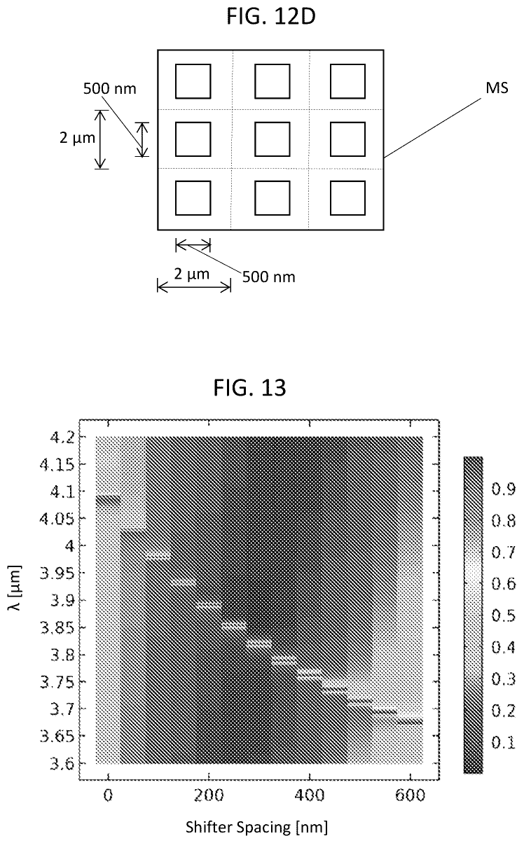

Another embodiment of inventive concepts is shown in FIGS. 12A, 12B, 12C, and 12D. In this embodiment, the waveguide core of FIGS. 1A-C is replaced by a metasurface MS. For the example shown, the metasurface MS includes an As₂S₃ film with an array of 500 nm×500 nm square holes therethrough with 2 μm center spacings between adjacent holes in both the vertical and horizontal directions (thereby defining 2 μm×2 μm unit cells). FIG. 12D illustrates an expanded view of metasurface MS with dashed lines indicating 2 μm×2 μm unit cells. Shifter 125 is also an As₂S₃ film. FEM modelling illustrated in the graph of FIG. 13 shows a wide tuning range of approximately 400 nm for peak reflectance of midwave infrared MWIR light, with a shift in resonance position of greater than 400 nm.

Embodiments of FIGS. 12A-12D thus provide a dynamically tunable metasurface, where resonance of the metasurface is shifted as s is varied. For example, a laser may transmit an incident laser beam through substrate 115 to metasurface MS which may act as a tunable filter responsive to spacing s to that the resulting reflected optical beam has a resonance that is shifted responsive to spacing s. As shown in FIG. 13, by varying shifter spacings s of FIG. 12A from 0 nm to 600 nm, tuning of reflected wavelength resonance may be shifted by more than 400 nm (i.e., from about 4.1 μm to less than about 3.7 μm). According to some other embodiments, shifter 125 may be directly on metasurface MS (i.e., s=0), and changes is pressure between shifter 125 and metasurface 125 may be used to shift resonance.

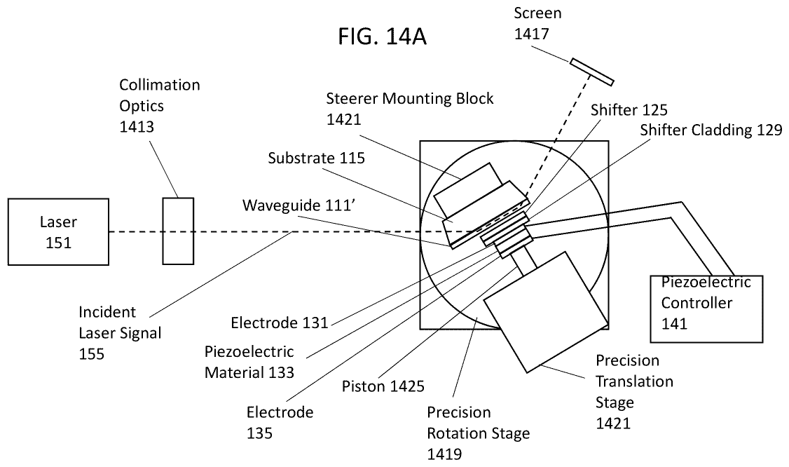

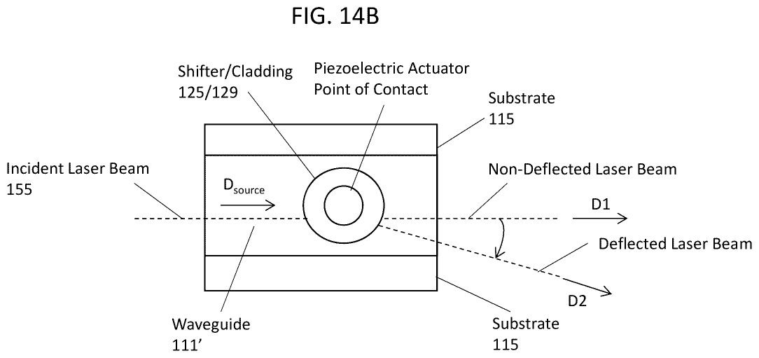

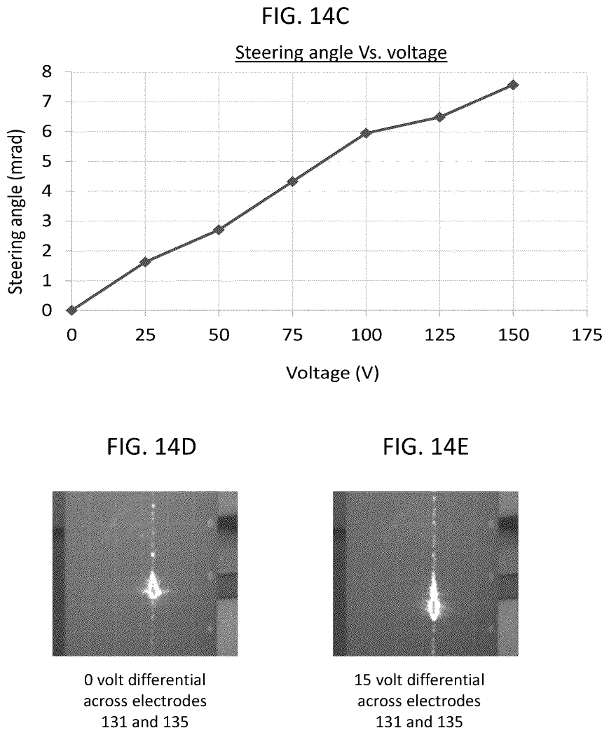

FIGS. 14A, 14B, 14C, 14D, and 14E illustrate an experimental set up demonstrating beam steering through waveguide core 111′ similar to some embodiments discussed above with respect to FIG. 4 where substrate 115 is a CaF₂ substrate, waveguide 125 is a 500 nm thick layer of As₂S₃, piezoelectric material 133 is PZT providing 9.5 μm of travel (i.e., a change in spacing s) responsive to a change of 150 volts across electrodes 131 and 135, and laser input (incident laser beam) is provided by a quantum cascade laser having wavelength λ=4.7 μm. Together, substrate 115 and waveguide core 111′ may be referred to as a steerer/steering chip. In FIG. 14A, a primary surface of substrate 115 is oriented perpendicular with respect to the plane of the page, and the piezoelectric actuator (including piezoelectric material 133 and electrodes 131 and 135) provides movement of shifter 125 in a direction parallel with respect to the plane of the page. As shown, an output of laser 151 may be collimated by collimation optics 1413 to provide incident laser signal 155 that enters waveguide 111′ through substrate 115, that exits waveguide 111′ through substrate 115, and that is sensed on screen 1417.

As shown in FIG. 14A, both substrate 115 and shifter 125 are mounted (indirectly) on precision rotation stage 1419. More particularly, steerer mounting block 1421 extends from the rotation stage and provides a mounting for substrate 115 such that the waveguide 111′ faces shifter 125, and precision translation stage 1423 (including the piston 1425) is mounted on rotation stage 1419 to position shifter 125 facing waveguide 111′. For example, precision translation stage 1419 is configured to provide a desired distance/space between waveguide 111′ and shifter 125 by extending/retracting piston 1425, and the piezoelectric actuator is configured to precisely control the spacing s between waveguide 111′ and shifter 125 to provide a desired beam steering of laser signal 155 responsive to an electrical signal applied by piezoelectric controller 141 across electrodes 131 and 135.

In FIG. 14B, the primary surface of substrate 115 is oriented parallel with respect to the plane of the page to illustrate beam steering that may be provided. In the experimental set up of FIG. 14A, incident laser beam signal 155 from the laser enters waveguide 111′ from a source direction D_{source} (from the left), and a steering/deflection of the laser beam signal in the plane of waveguide 111′ is determined based on the spacing s between waveguide 111′ and shifter 125. As shown in FIG. 14B, shifter 125 has a circular shape (in a plane parallel with a primary surface of substrate 115) so that a side surface of shifter 125 is non-orthogonal with respect to the source direction of the incident laser beam. According to some other embodiments, shifter 125 may have a triangular shape in a plane parallel with the primary surface of substrate 115.

In the graph of FIG. 14C, the voltage applied across electrodes 131 and 135 is shown on the x-axis, and the resulting steering angle is shown by the curve with respect to the y-axis. FIG. 14D illustrates the output of zero degrees steering angle with 0 volts applied across electrodes 131 and 135, and FIG. 14E illustrates the output of 7.5 degrees steering angle with 150 volts applied across electrodes 131 and 135. Accordingly, the beam steering angle is controlled by controlling the voltage applied across electrodes 131 and 135 of the piezoelectric actuator.

Table II provides a comparison between piezo-shifting according to embodiments of present inventive concepts and other technologies based on electro-optic effect, liquid crystal LC cladding, and MEMS shifting.

TABLE 2
Technology Comparison Chart

| | Loss | | Δn_{eff} | Multi-band | Area | Speed |
|---|---|---|---|---|---|---|
| Electro- | <0.1 | dB/cm | 10⁻⁴ | VIS through | Several | >100 |
| Optic | | | | MWIR | cm | GHz |
| Effect | | | | | | |
| LC- | ~1 | dB/cm | 0.01 | NIR through | Several | >1 |
| cladding | | | | MWIR | cm | kHz |

| | | | | | |
|---|---|---|---|---|---|
| MEMS | Near Intrinsic | 0.03 | Engineering | ~100 μm | >10 |
| shifting | Waveguide Loss | | Required for | | kHz |
| | | | new Bands | | |
| Piezo | Near Intrinsic | >0.05 | Works in | Several | >100 |
| Shifting | Waveguide Loss | | any band | cm | kHz |

As shown in Table 2, piezo shifting according to embodiments of inventive concepts may provide the highest Δn_{eff} for use across a large spectral band, over a large area, and at high speed.

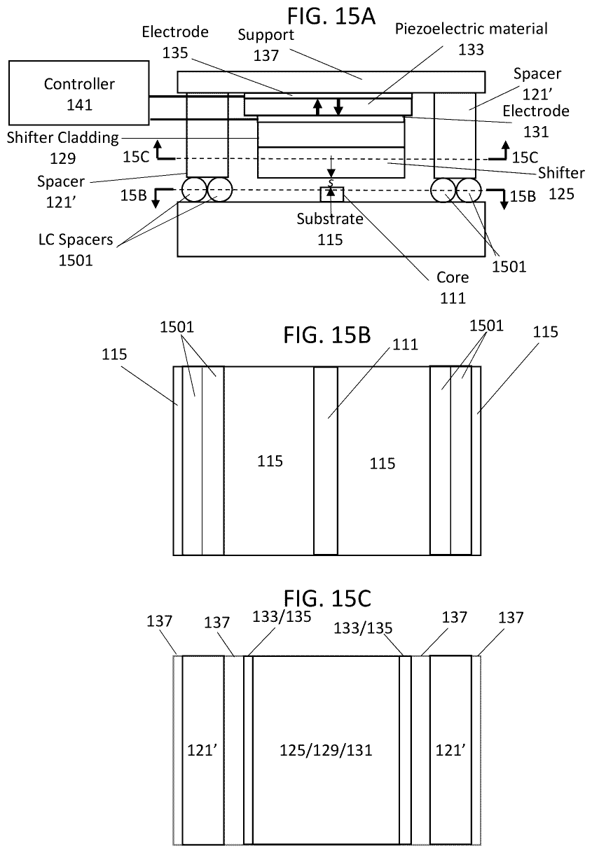

FIGS. 15A, 15B, and 15C are side and sectional views illustrating an optical device according to some embodiments of inventive concepts. Embodiments of FIGS. 15A, 15B, and 15C are similar to embodiments of FIGS. 1A, 1B, and 1C, operations of embodiments of FIGS. 1A-C and 15A-C are substantially the same, and like reference numbers refer to like elements. In FIGS. 15A and 15C, however, spacers 121′ may be glass spacers formed/provided on support 137 and polished together with shifter 125 so that bottom surfaces of spacers 121′ and shifter 125 are co-planar prior to assembly with substrate 115 and waveguide core 111. More particularly, electrode 135, piezoelectric material 133, electrode 131, shifter cladding 129, and shifter 125 may be formed/provided on support 137; spacers 121′ may be formed/provided on support 137; and surfaces of spacers 121′ and shifter 125 may then be polished to be co-planar.

After polishing, spherical liquid crystal (LC) spacers 1501 may be used to provide uniform spacing between spacers 121′ and substrate 115 as shown in FIGS. 15A and 15B. LC spacers are discussed, for example, in the on-line publication by EPRUI Biotech Co. Ltd., “LCD Spacer” (China, 2016-2021, 5 pages, https://www.chromspheres.com/lcd-spacer/), the disclosure of which is hereby incorporated herein in its entirety by reference. By providing that surfaces of shifter 125 and spacers 121′ are co-planar (e.g., by polishing) and using uniformly sized spherical LC spacers 1501, surfaces of substrate 115 and shifter 125 may be provided/maintained in parallel. While not shown in FIG. 15A or FIG. 15B, an adhesive (e.g., solder) may be used to secure spacers 121′ and LC spacers 1501 on substrate 115.

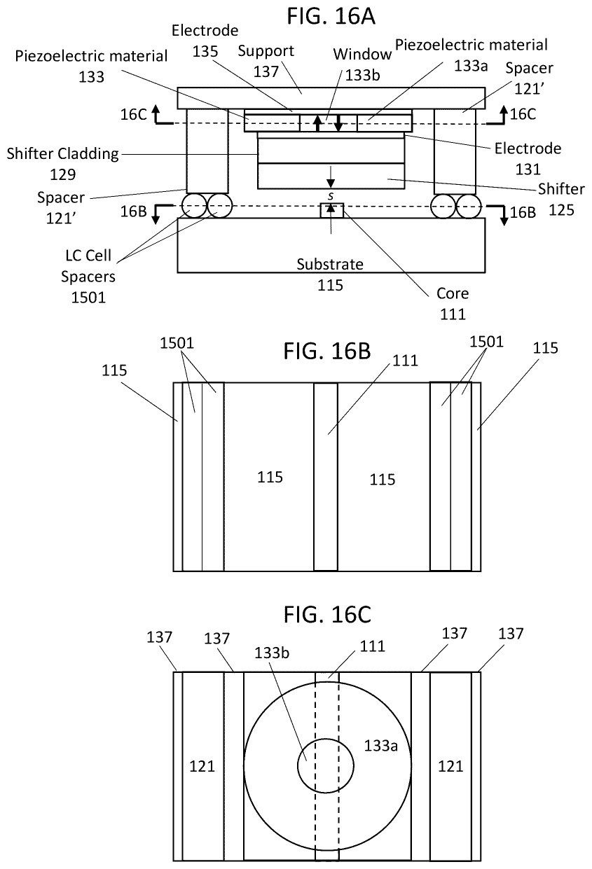

FIGS. 16A, 16B, and 16C are side and sectional views illustrating an optical device according to some embodiments of inventive concepts. Embodiments of FIGS. 16A, 16B, and 16C are similar to embodiments of FIGS. 15A, 15B, and 15C, operations of embodiments of FIGS. 16A-C and 15A-C are substantially the same, and like reference numbers refer to like elements. In FIGS. 16A and 16C, piezoelectric material 133a may define a window/opening 133b therethrough, and provided that support 137, electrode 135, electrode 131, shifter cladding 129, and shifter 125 are sufficiently transparent, a portion of core 111 may be visible through window 133b to facilitate alignment and/or ease of manufacture.

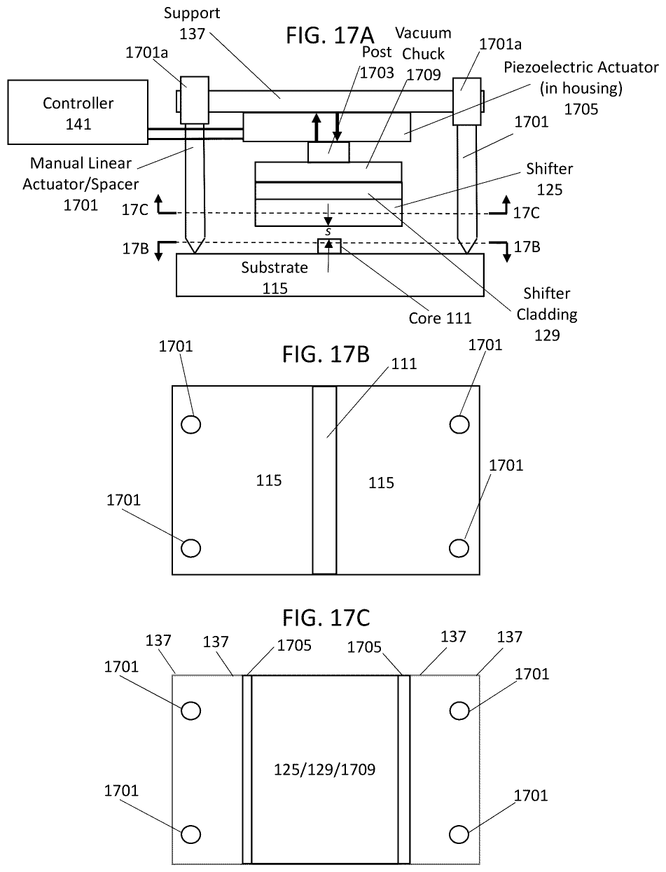

FIGS. 17A, 17B, and 17C are side and sectional views illustrating an optical device according to some embodiments of inventive concepts. Embodiments of FIGS. 17A, 17B, and 17C are similar to embodiments of FIGS. 1A, 1B, and 1C, operations of embodiments of FIGS. 1A-C and 17A-C are substantially the same, and like reference numbers refer to like elements. In FIGS. 17A, 17B, and 17C, manual linear actuators 1701 may be used in place of spacers 121 to provide course adjustment of spacing between shifter 125 and core 111, an amplified piezoelectric actuator 1705 in a housing may be used in place of separately formed electrodes and piezoelectric layer, and post 1703 and vacuum chuck 1709 may provide coupling between piezoelectric actuator 1705 and shifter/cladding 125/129.

For example, each manual linear actuator 1701 may include a thumb screw 1701a to provide coarse linear adjustment allowing control of space s and/or leveling of shifter 125 relative to core 111. While four linear actuators are shown by way of example, other embodiments may use two or three linear actuators, a single linear actuator with a tip/tilt stage, or more than four linear actuators.

Amplified piezoelectric actuator 1705, for example, may be provided as disclosed, for example, by Thorlabs in “APF503, APF705, APF710 Amplified Piezo Actuators: User Guide,” (NTN032440-D02, 18 pages, Rev. C, August 2019), the disclosure of which is hereby incorporated herein in its entirety by reference. Amplified piezoelectric actuator 1705 may thus be provided as a pre-fabricated piezoelectric actuator in a housing to avoid manufacturing/forming a piezoelectric actuator on support 137.

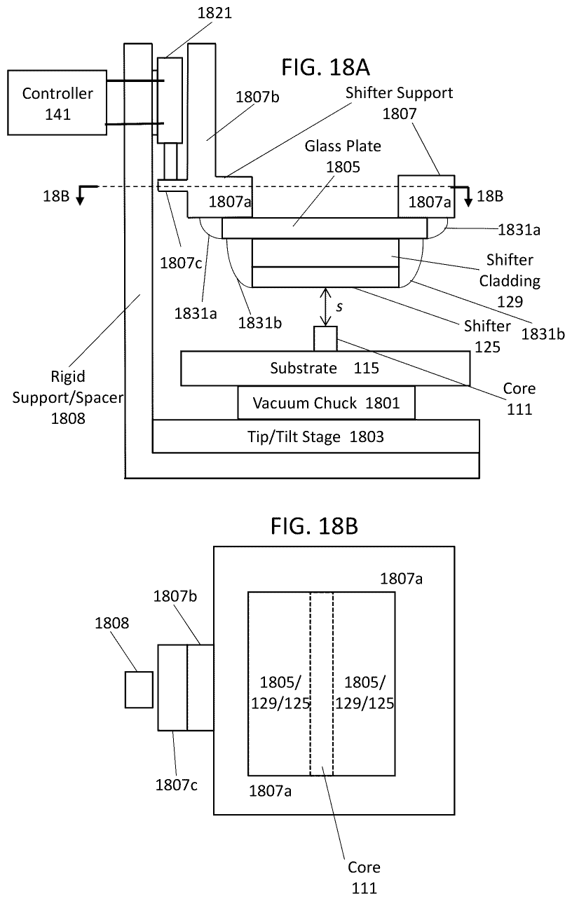

FIGS. 18A and 18B are side and sectional views illustrating an optical device according to some embodiments of inventive concepts. Embodiments of FIGS. 18A and 18B are similar to embodiments of FIGS. 1A, 1B, and 1C, operations of embodiments of FIGS. 1A-C and 18A-B are substantially the same, and like reference numbers refer to like elements. In FIGS. 18A and 18B, however, a single rigid support 1808 (also referred to as a spacer) may be used to mount shifter cladding 129 and shifter 125 relative to core 111 and substrate 115, modular piezoelectric actuator 1821 may provide both course and fine positioning of shifter 125 relative to core 111, and tip/tilt stage 1803 may provide alignment of shifter 125 surface relative to core 111 and/or substrate 115. Modular piezoelectric actuator 1821 may be provided, for example, as discussed by Thorlabs in “Modular Piezoelectric Actuators,” 5 pages, Oct. 30, 2023.

Moreover, shifter/cladding 125/129 may be mounted on shifter support 1807 including a frame portion 1807a, vertical support portion 1807b, and actuator portion 1807. Substrate 115 may be secured using vacuum chuck 1801, shifter/cladding 125/129 may be provided on glass plate 1805, glass plate 1805 may be secured to frame portion 1807a of shifter support using clamps 1831a, and shifter/cladding 125/129 may be secured to glass plate 1805 using clamps 1831b.

An example embodiment of an optical device is discussed below with respect to FIGS. 1A, 1B, 1C, and 1D. The optical device may include substrate 115, core 111 (also referred to as an optical element) on a surface of substrate 115, shifter 125 adjacent to core 111, a piezoelectric actuator coupled with shifter 125, controller 141 coupled with the piezoelectric actuator, and laser source 151 configured to provide a laser beam to core 111. More particularly, shifter 125 is mounted adjacent to core 111 such that core 111 is between substrate 115 and shifter 125. Moreover, the piezoelectric actuator includes piezoelectric material 133 between electrodes 131 and 133, and the piezoelectric actuator is configured to change a space s between core 111 and shifter 125. In FIGS. 1A-D, the laser beam is transmitted through core 111, with core 111 providing confinement of the laser beam in two dimensions that are orthogonal with respect to a direction of transmission of the laser beam through core 111.

Moreover, controller 141 is configured to apply a first electrical signal to the piezoelectric actuator (across/through electrodes 131 and 135) to provide a first space s between core 111 and shifter 125 responsive to the first electrical signal. Controller 141 is further configured to apply a second electrical signal to the piezoelectric actuator (through/across electrodes 131 and 135) to provide a second space s between core 111 and shifter 125, such that the first and second spacings are different. Stated in other words, controller 141 controls/changes a distance between core 111 and shifter 125 by changing an electrical signal applied to the actuator.

According to some embodiments of FIG. 1A-D, a first effective index n_{eff} and/or a first dispersion is applied to the laser beam responsive to the first space, and a second effective index and/or a second dispersion is applied to the laser beam responsive to the second space. Moreover, the first effective index and/or the first dispersion (resulting from the first space s) is different that the second effective index and/or the second dispersion (resulting from the second space s).

According to some embodiments of FIGS. 1A-D, a first tuning of the laser beam is provided in response to the first spacing s, and a second tuning of the laser beam is provided in response to the second spacing s. Moreover, the first tuning of the laser beam (resulting from the first space s) and the second tuning of the laser beam (resulting from the second spacing s) are different.

The optical device of FIGS. 1A-D may also include shifter cladding 129 on shifter 125 with shifter 125 between shifter cladding 129 and core 111. Moreover, a refractive index of shifter cladding 129 may be lower than a refractive index of shifter 125.

Shifter 125 of FIGS. 1A-D may include first shifter layer 125a and second shifter layer 125b having different refractive indices as discussed with respect to FIG. 3. While not shown explicitly in FIGS. 1A-D, piezoelectric material 133 may define a window therethrough as discussed with respect to FIGS. 16A-C.

Another example embodiment of an optical device is discussed below with respect to FIGS. 2A, 2B, 2C, and 2D. While not explicitly shown in FIGS. 2A-D, the optical device may be provided on a device substrate with controller 141 and laser sourer 151 as discussed with respect to FIG. 1D. The optical device may include substrate 115, core 111 (also referred to as an optical element) on a surface of substrate 115, shifter 125 on core 111, a piezoelectric actuator coupled with shifter 125, controller 141 coupled with the piezoelectric actuator, and a laser source configured to provide a laser beam to core 111. More particularly, shifter 125 is mounted on core 111 such that core 111 is between substrate 115 and shifter 125. Moreover, the piezoelectric actuator includes piezoelectric material 133 between electrodes 131 and 133, and the piezoelectric actuator is configured to change a pressure between core 111 and shifter 125. In FIGS. 2A-D, the laser beam is transmitted through core 111, with core 111 providing confinement of the laser beam in two dimensions that are orthogonal with respect to a direction of transmission of the laser beam through core 111.

Moreover, controller 141 is configured to apply a first electrical signal to the piezoelectric actuator (across/through electrodes 131 and 135) to provide a first pressure between core 111 and shifter 125 responsive to the first electrical signal. Controller 141 is further configured to apply a second electrical signal to the piezoelectric actuator (through/across electrodes 131 and 135) to provide a second pressure between core 111 and shifter 125, such that the first and second pressures are different. Stated in other words, controller 141 controls/changes a pressure between core 111 and shifter 125 by changing an electrical signal applied to the actuator.

According to some embodiments of FIG. 2A-D, a first effective index n_{eff} and/or a first dispersion is applied to the laser beam responsive to the first pressure, and a second effective index and/or a second dispersion is applied to the laser beam responsive to the second pressure. Moreover, the first effective index and/or the first dispersion (resulting from the first pressure) is different that the second effective index and/or the second dispersion (resulting from the second pressure).

According to some embodiments of FIGS. 2A-D, a first tuning of the laser beam is provided in response to the first pressure, and a second tuning of the laser beam is provided in response to the second pressure. Moreover, the first tuning of the laser beam (resulting from the first pressure) and the second tuning of the laser beam (resulting from the second pressure) are different.

The optical device of FIGS. 2A-D may also include shifter cladding 129 on shifter 125 with shifter 125 between shifter cladding 129 and core 111. Moreover, a refractive index of shifter cladding 129 may be lower than a refractive index of shifter 125.

Shifter 125 of FIGS. 2A-D may include first shifter layer 125a and second shifter layer 125b having different refractive indices as discussed with respect to FIG. 3. While not shown explicitly in FIGS. 2A-D, piezoelectric material 133 may define a window therethrough as discussed with respect to FIGS. 16A-C.

Still another example embodiment of an optical device is discussed below with respect to FIGS. 4 and 14A-B. While not explicitly shown in FIGS. 4 and 14A-B, the optical device may include a controller 141 and a laser sourer 151 as discussed with respect to FIGS. 1A-D. The optical device may include substrate 115, waveguide 111′ (also referred to as an optical element) on a surface of substrate 115, shifter 125 adjacent to waveguide 111′, a piezoelectric actuator coupled with shifter 125, controller 141 coupled with the piezoelectric actuator, and a laser source configured to provide a laser beam to waveguide 111′. More particularly, shifter 125 is mounted adjacent to waveguide 111′ such that waveguide 111′ is between substrate 115 and shifter 125. Moreover, the piezoelectric actuator includes piezoelectric material 133 between electrodes 131 and 133, and the piezoelectric actuator is configured to change a space s between waveguide 111′ and shifter 125. In FIGS. 4 and 14A-B, the laser beam is transmitted through waveguide 111′, with waveguide 111′ having a first dimension that is perpendicular with respect to the surface of substrate 115 and a second dimension that is parallel with respect to the surface of the substrate 115, with the second dimension being greater than the first dimension and greater than a width of the laser beam. Accordingly, waveguide 111′ may not confine the laser beam in the second dimension.

Moreover, controller 141 is configured to apply a first electrical signal to the piezoelectric actuator (across/through electrodes 131 and 135) to provide a first space s between waveguide 111′ and shifter 125 responsive to the first electrical signal. Controller 141 is further configured to apply a second electrical signal to the piezoelectric actuator (through/across electrodes 131 and 135) to provide a second space s between waveguide 111′ and shifter 125, such that the first and second spacings are different. Stated in other words, controller 141 controls/changes a distance between waveguide 111′ and shifter 125 by changing an electrical signal applied to the actuator.

Shifter 125 may thus be configured to steer the laser beam in a first direction D1 in response to the first spacing and to steer the beam signal in a second direction D2 in response to the second spacing, with the first and second directions being different. More particularly, the first direction D1 and the second direction D2 may be parallel with respect to the surface of substrate 115, and/or the shifter may have at least one side surface that is non-orthogonal with respect to a source direction D_{source} of the laser beam. Moreover, shifter 125 may have a circular or a triangular shape in a plane that is parallel with the surface of substrate 115.

The optical device of FIGS. 4 and 14A-B may also include shifter cladding 129 on shifter 125 with shifter 125 between shifter cladding 129 and waveguide 111′. Moreover, a refractive index of shifter cladding 129 may be lower than a refractive index of shifter 125.

Shifter 125 of FIGS. 4 and 14A-B may include first shifter layer 125a and second shifter layer 125b having different refractive indices as discussed with respect to FIG. 3. While not shown explicitly in FIGS. 4 and 14A-B, piezoelectric material 133 may define a window therethrough as discussed with respect to FIGS. 16A-C.

While not explicitly shown in FIGS. 4 and 14A-B, shifter 125 may be directly on waveguide 111′ such that changes in pressure (instead of changes in spacing) between shifter 125 and waveguide 111′ are used to steer the laser beam.

Yet another example embodiment of an optical device is discussed below with respect to FIGS. 12A, 12B, 12C, and 12D. The optical device may include substrate 115, metasurface MS (also referred to as an optical element) on a surface of substrate 115, shifter 125 adjacent to metasurface MS (e.g., defining an array/pattern of holes therethrough), a piezoelectric actuator coupled with shifter 125, controller 141 coupled with the piezoelectric actuator, and a laser source configured to provide a laser beam to metasurface MS. More particularly, shifter 125 is mounted adjacent to metasurface MS such that metasurface MS is between substrate 115 and shifter 125. Moreover, the piezoelectric actuator includes piezoelectric material 133 between electrodes 131 and 133, and the piezoelectric actuator is configured to change a space s between metasurface MS and shifter 125. In FIGS. 12A-D, the laser beam may be transmitted through substrate 115 to metasurface MS.

Moreover, controller 141 is configured to apply a first electrical signal to the piezoelectric actuator (across/through electrodes 131 and 135) to provide a first space s between metasurface MS and shifter 125 responsive to the first electrical signal. Controller 141 is further configured to apply a second electrical signal to the piezoelectric actuator (through/across electrodes 131 and 135) to provide a second space s between metasurface MS and shifter 125, such that the first and second spacings are different. Stated in other words, controller 141 controls/changes a distance between metasurface MS and shifter 125 by changing an electrical signal applied to the actuator. Accordingly, metasurface MS is configured to reflect the beam having a first tuning responsive to the first space and to reflect the beam having a second tuning responsive to the second space, with the first and second tunings being different.

The optical device of FIGS. 12A-D may also include shifter cladding 129 on shifter 125 with shifter 125 between shifter cladding 129 and metasurface MS. Moreover, a refractive index of shifter cladding 129 may be lower than a refractive index of shifter 125.

Shifter 125 of FIGS. 12A-D may include first shifter layer 125a and second shifter layer 125b having different refractive indices as discussed with respect to FIG. 3. While not shown explicitly in FIGS. 12A-D, piezoelectric material 133 may define a window therethrough as discussed with respect to FIGS. 16A-C.

While not explicitly shown in FIGS. 12A-D, shifter 125 may be directly on waveguide 111′ such that changes in pressure (instead of changes in spacing) between shifter 125 and metasurface MS are used to tune the laser beam.

Some embodiments of inventive concepts may provide one or more of the following advantages in comparison with other devices and methods of active n_{eff}/dispersion tuning. Some embodiments may provide methods of active n_{eff} tuning with one or more of: Low optical loss (near intrinsic waveguide loss); high speed tuning (potentially >100 kHz); capacity to modify the index over a large area (e.g., several cm²); and/or wavelength independence (e.g., the method may work in any band as long as appropriate waveguide materials exist), meaning it can function in many/all bands of interest, e.g., UV through LWIR. Some embodiments may provide methods of active waveguide dispersion tuning where other practical methods are currently unavailable. Some embodiments may provide potential improvements in performance for NMBS applications with one or more of: ˜10× reduction in loss; ˜5× increase in steering; and/or ˜10× increase in speed.

Some embodiments of inventive concepts may be implemented according to a variety of alternatives. For example, the waveguide geometry may be implemented using any type used in integrated optics including rib, ridge, buried channel, strip-loaded, diffused, etc. Shifter 125 may be multi-layer, including any arbitrary number of layers to provide better control over n_{eff} and/or dispersion. The device may be operated in a combination mode where in some cases the shifter assembly is translated with respect to the waveguide/core and in others it is in contact with the waveguide/core and a variable pressure is applied. With suitable shifter design, the shifter assembly may provide a high speed, high isolation optical switch such that the optical mode primarily or entirely propagates within the shifter rather than the waveguide core when s is sufficiently small. Some embodiments of inventive concepts may also be used outside of the ultraviolet to LWIR wavelength range. For example, some embodiments may be used in the terahertz and/or microwave wavebands.

The terminology used herein is for the purpose of describing particular embodiments only and is not intended to be limiting of inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. The term “and/or” includes any and all combinations of one or more of the associated listed items.

Spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein may be interpreted accordingly.

It will be understood that, although the terms first, second, third, etc. may be used herein to describe various elements, these elements should not be limited by these terms. These terms are only used to distinguish one element from another element. Thus, a first element discussed herein could be termed a second element without departing from the scope of the present inventive concepts.

It will also be understood that when an element is referred to as being “on,” “connected” to/with, or “coupled” to/with another element, it can be directly on, directly connected to/with, or directly coupled to/with the other element, or intervening elements may be present. In contrast, when an element is referred to as being “directly on”, “directly connected” to/with, or “directly coupled” to/with another element, there are no intervening elements present. Moreover, if an element is referred to as being “on” another element, no spatial orientation is implied such that the element can be over the other element, under the other element, on a side of the other element, etc.

Embodiments are described herein with reference to cross-sectional and/or perspective illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, a region illustrated as a rectangle may, typically, have rounded or curved features. Thus, the regions illustrated in the figures are schematic in nature and their shapes are not intended to illustrate the actual shape of a region of a device and are not intended to limit the scope of present inventive concepts.

The operations of any methods disclosed herein do not have to be performed in the exact order disclosed, unless an operation is explicitly described as following or preceding another operation and/or where it is implicit that an operation must follow or precede another operation. Any feature of any of the embodiments disclosed herein may be applied to any other embodiment, wherever appropriate. Likewise, any advantage of any of the embodiments may apply to any other embodiments, and vice versa. Other objectives, features and advantages of the disclosed embodiments will be apparent from the description herein.

Unless otherwise defined, all terms (including technical and scientific terms) used herein have the same meaning as commonly understood by one of ordinary skill in the art to which the inventive concepts herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While inventive concepts have been particularly shown and described with reference to examples of embodiments thereof, it will be understood that various changes in form and details may be made therein without departing from the spirit of the following claims.

1. An optical device comprising:
a substrate having a surface;
an optical element on the surface of the substrate;
a shifter adjacent to the optical element such that the optical element is between the substrate and the shifter; and
an actuator coupled with the shifter, wherein the actuator is configured to change a space and/or a pressure between the optical element and the shifter.

2. The optical device according to claim 1 further comprising:
a controller coupled with the actuator, wherein the controller is configured to apply a first electrical signal to the actuator to provide a first space and/or a first pressure between the optical element and the shifter responsive to the first electrical signal, wherein the controller is configured to apply a second electrical signal to the actuator to provide a second space and/or a second pressure between the optical element and the shifter, and wherein the first space and/or the first pressure is different than the second space and/or the second pressure.

3. The optical device according to claim 2, wherein the actuator comprises a piezoelectric actuator having a piezoelectric material between a first electrode and a second electrode, and wherein the controller is configured to apply the first electrical signal across the first and second electrodes and to apply the second electrical signal across the first and second electrodes.

4. The optical device according to claim 2 further comprising:
a laser source configured to provide a laser signal to the optical element, wherein a first effective index and/or a first dispersion is applied to the laser signal responsive to the first space and/or the first pressure, wherein a second effective index and/or a second dispersion is applied to the laser signal responsive to the second space and/or the second pressure, and wherein the first effective index and/or the first dispersion is different that the second effective index and/or the second dispersion.

5. The optical device according to claim 2 further comprising:
a laser source configured to provide a laser signal to the optical element, wherein a first tuning of the laser signal is provided in response to the first spacing and/or the first pressure, wherein a second tuning of the laser signal is provided in response to the second spacing and/or the second pressure, and wherein the first tuning of the laser signal and the second tuning of the laser signal are different.

6. The optical device according to claim 5, wherein the laser signal comprises a laser beam that is transmitted through the optical element, and wherein the optical element provides confinement of the laser beam in two dimensions that are orthogonal with respect to a direction of transmission of the laser beam through the optical element.

7. The optical device according to claim 2 further comprising:
a laser source configured to provide a laser signal to the optical element, wherein the shifter is configured to steer the laser signal in a first direction in response to the first spacing and/or the first pressure, wherein the shifter is configured to steer the laser signal in a second direction in response to the second spacing and/or the second pressure, and wherein the first and second directions are different.

8. The optical device according to claim 7, wherein the laser signal comprises a laser beam, wherein the optical element comprises a waveguide having a first dimension that is perpendicular with respect to the surface of the substrate and a second dimension that is parallel with respect to the surface of the substrate, wherein the second dimension is greater than the first dimension and greater than a width of the laser beam.

9. The optical device according to claim 8, wherein the first direction and the second direction are parallel with respect to the surface of the substrate.

10. The optical device according to claim 9, wherein the shifter has at least one side surface that is non-orthogonal with respect to a source direction of the laser signal.

11. The optical device according to claim 10, wherein the shifter has a circular or a triangular shape in a plane that is parallel with the surface of the substrate.

12. The optical device according to claim 2 further comprising:
a laser source configured to direct a laser beam to the optical element, wherein the optical element is configured to reflect the beam having a first tuning responsive to the first space and/or pressure and to reflect the beam having a second tuning responsive to the second space and/or pressure, and wherein the first tuning and the second tuning are different.

13. The optical device according to claim 12, wherein the optical element comprises an array of features having dimensions that are less than a wavelength of the laser signal.

14. The optical device according to claim 13, wherein the array of features comprises an array of holes and/or pillars.

15. The optical device according to claim 1 further comprising:
shifter cladding on the shifter, wherein the shifter is between the shifter cladding and the optical element, and wherein a refractive index of the shifter cladding is lower than a refractive index of the shifter.

16. The optical device according to claim 1, wherein the shifter comprises a first shifter layer and a second shifter layer having different refractive indices.

17. The optical device according to claim 3, wherein the piezoelectric material defines a window therethrough.

18. A method of processing a laser signal, the method comprising:
providing the laser signal to an optical element;
providing a first spacing and/or a first pressure between the optical element and a shifter, while providing the laser signal to the optical element; and
after providing the first spacing and/or the first pressure, providing a second spacing and/or a second pressure between the optical element and the shifter while providing the laser signal to the optical element, wherein the first spacing and/or the first pressure are different than the second spacing and/or the second pressure.

19. The method according to claim 18, wherein the shifter is coupled with an actuator, wherein providing the first spacing and/or the first pressure comprises providing a first electrical signal to the actuator, wherein providing the second spacing and/or the second pressure comprises providing a second electrical signal to the actuator, and wherein the first and second electrical signals are different.

20. The method according to claim 19, wherein the actuator comprises a piezoelectric actuator having a piezoelectric material between a first electrode and a second electrode, wherein the first electrical signal is applied across the first and second electrodes, and wherein the second electrical signal is applied across the first and second electrodes.

21. The method according to claim 18, wherein a first effective index and/or a first dispersion is applied to the laser signal responsive to the first space and/or the first pressure, wherein a second effective index and/or a second dispersion is applied to the laser signal responsive to the second space and/or the second pressure, and wherein the first effective index and/or the first dispersion is different that the second effective index and/or the second dispersion.

22. The method according to claim 18, wherein a first tuning of the laser signal is provided in response to the first spacing and/or the first pressure, wherein a second tuning of the laser signal is provided in response to the second spacing and/or the second pressure, and wherein the first tuning of the laser signal and the second tuning of the laser signal are different.

23. The method according to claim 22, wherein providing the laser signal comprises transmitting a laser beam through the optical element, and wherein the optical element provides confinement of the laser beam in two dimensions that are orthogonal with respect to a direction of transmission of the laser beam through the optical element.

24. The method according to claim 18, wherein the laser signal is steered in a first direction through the optical element in response to the first spacing and/or the first pressure, wherein the laser signal is steered in a second direction through the optical element in response to the second spacing and/or the second pressure, and wherein the first and second directions are different.

25. The method according to claim 24, wherein providing the laser signal comprises transmitting a laser beam through the optical element, wherein the optical element comprises a waveguide having a first and second dimensions that are orthogonal with respect to each other and that are orthogonal with respect to a source direction of transmission of the laser beam, and wherein the second dimension is greater than the first dimension and greater than a width of the laser beam.

26. The method according to claim 18, wherein the optical element is configured to reflect the laser signal having a first tuning responsive to the first space and/or pressure and to reflect the laser signal having a second tuning responsive to the second space and/or pressure, and wherein the first tuning and the second tuning are different.

27. The method according to claim 26, wherein the optical element comprises a metasurface on a substrate.

28. The method according to claim 27, wherein the metasurface comprises an array of features having dimensions that are less than a wavelength of the laser signal.

29. The method according to claim 28, wherein the array comprises an array of holes and/or pillars.
